(19) United States
(12) Patent Application Publication
(10) Pub. No.: US 2012/0237916 A1
(43) Pub. Date: Sep. 20, 2012

(54) DISPLAY CONTROL DEVICE, QUESTION INPUT DEVICE, AND COMPUTER PROGRAM PRODUCT

(75) Inventor: Yohei Fujita, Kanagawa (JP)

(73) Assignee: RICOH COMPANY, LIMITED, Tokyo (JP)

(21) Appl. No.: 13/415,245

(22) Filed: Mar. 8, 2012

(30) Foreign Application Priority Data
Mar. 18, 2011 (JP) 2011-061566
Dec. 27, 2011 (JP) 2011-286644

(51) Int. Cl. G09B 7/00

(52) U.S. Cl. 434/324

(57) ABSTRACT

A display control device includes a question managing unit, a question image preparing unit, a page managing unit, and an image overlay unit. The question managing unit assigns identification information to question information and manages the question information. The question information includes a question detail of a question asked with an image displayed on a display specified and a question object page. The question image preparing unit prepares a question image based on the question information. The page managing unit manages, when receiving a display request of the question, a display order and display time of the question object page to be displayed based on the identification information. The image overlay unit prepares an overlay image including the question image superimposed over the specified image. The page managing unit causes the overlay image to be displayed on the display through switching according to the display order and the display time.

### CROSS-REFERENCE TO RELATED APPLICATIONS

The present application claims priority to and incorporates by reference the entire contents of Japanese Patent Application No. 2011-061566 filed in Japan on Mar. 18, 2011 and Japanese Patent Application No. 2011-286644 filed in Japan on Dec. 27, 2011.

### BACKGROUND OF THE INVENTION

1. Field of the Invention

The present invention relates to a display control device, a question input device, and a computer program product.

2. Description of the Related Art

At such occasions as a lecture, a briefing, or a meeting given in an office or a university, an explanatory material prepared using a personal computer (PC) is projected onto a screen through a projector as an information projection device, while copies of the explanatory material are printed and handed out to attendees in advance. Employed in such a situation are a known projection-related technique to make wired or wireless connection between the PC and the projector and another known technique to print the material from the PC.

In a presentation that is given by referring to a slide material that may extend over a plurality of pages using a projector as described above, presentation time is very often set in advance and a presenter is required to finish his or her presentation within the preset time. It is troublesome for the presenter to give his or her presentation, while keeping track of elapsed time in order to finish the presentation within the preset time.

The following method has been developed in order to save the trouble. Japanese Patent Application Laid-open No. 2003-162274, for example, discloses a technique for registering time to be spent for each slide in advance, measuring elapsed time from the start of the presentation and elapsed time for each slide, and instructing the presenter when to switch images, so that the presenter can use the presentation time as scheduled.

The method of using the presentation time as scheduled by registering the time to be spent for each slide in advance, as in the technique disclosed in Japanese Patent Application Laid-open No. 2003-162274, however, involves a problem in that time for questions during a question-and-answer session after explanations using slides cannot be scheduled to thereby complete the question-and-answer session efficiently within a limited period of time.

Therefore, there is a need for a device that is capable of allowing a question-and-answer session to be conducted efficiently within a set period of time.

### SUMMARY OF THE INVENTION

According to an embodiment, there is provided a display control device that includes a question managing unit, a question image preparing unit, an operating unit, a page managing unit, and an image overlay unit. The question managing unit assigns identification control information to question information and manages the question information. The question information includes a question detail of a question asked with an image displayed on a display specified and a question object page indicating page number of the specified image. The question image preparing unit prepares a question image based on the question information. The operating unit receives various types of requests from outside. The page managing unit manages, when a display request of the question is received via the operating unit, a display order and display time of the question object page to be displayed based on the identification control information. The image overlay unit prepares an overlay image including the question image superimposed over the specified image. The page managing unit causes the overlay image to be displayed on the display through switching according to the display order and the display time.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a system configuration of an information projection system;

FIG. 2 is a functional block diagram illustrating a configuration of an information projection device and a question input device;

FIG. 3 is a sequence diagram illustrating a process for registering question-and-answer session time;

FIG. 4 is a schematic diagram illustrating a data structure of question time information;

FIG. 5 is a sequence diagram illustrating a process for registering question information;

FIG. 6 is a schematic diagram illustrating an input example during preparation of the question information;

FIG. 7 is a schematic diagram illustrating an example of question information;

FIG. 8 is a front view illustrating a display image for inputting items of weighting information and uniform distribution information;

FIG. 9 is a schematic diagram illustrating a data structure of the question information;

FIG. 10 is a schematic diagram illustrating an example of question information;

FIG. 11 is a sequence diagram illustrating a process for starting a question-and-answer session;

FIG. 12 is a schematic diagram illustrating an example of a table;

FIGS. 13A and 13B are schematic diagrams illustrating a method for preparing a question image;

FIG. 14 is a front view illustrating an example of a screen that shows a residual time of a question;

FIG. 15 is a sequence diagram illustrating a process for starting the question-and-answer session;

FIG. 16 is a sequence diagram illustrating a process for starting the question-and-answer session;

FIG. 17 is a view illustrating a display image during presentation and an image displayed after the presentation;

FIG. 18 is a flowchart illustrating a scheduling process;

FIG. 19 is a diagram illustrating an example of a priority order determined based on the weighting information of the question information;

FIG. 20 is a flowchart illustrating a scheduling process;

FIG. 21 is a diagram illustrating an example of a priority order determined based on the uniform distribution information of the question information;

FIG. 22 is a flowchart illustrating a scheduling process;

FIG. 23 is a flowchart illustrating a scheduling process;

FIG. 24 is a schematic diagram illustrating an example of specifications of priority levels;

FIG. 25 is a flowchart illustrating a scheduling process;

FIG. 26 is a flowchart illustrating a rescheduling process;

FIG. 27 is a diagram illustrating specific examples of the rescheduling process;

FIG. 28 is a functional block diagram illustrating a configuration of an information projection device; and

FIG. 29 is a functional block diagram illustrating a configuration of a system including an information processing device.

### DETAILED DESCRIPTION OF THE PREFERRED EMBODIMENTS

Embodiments of the present invention will be described in detail below with reference to the accompanying drawings.

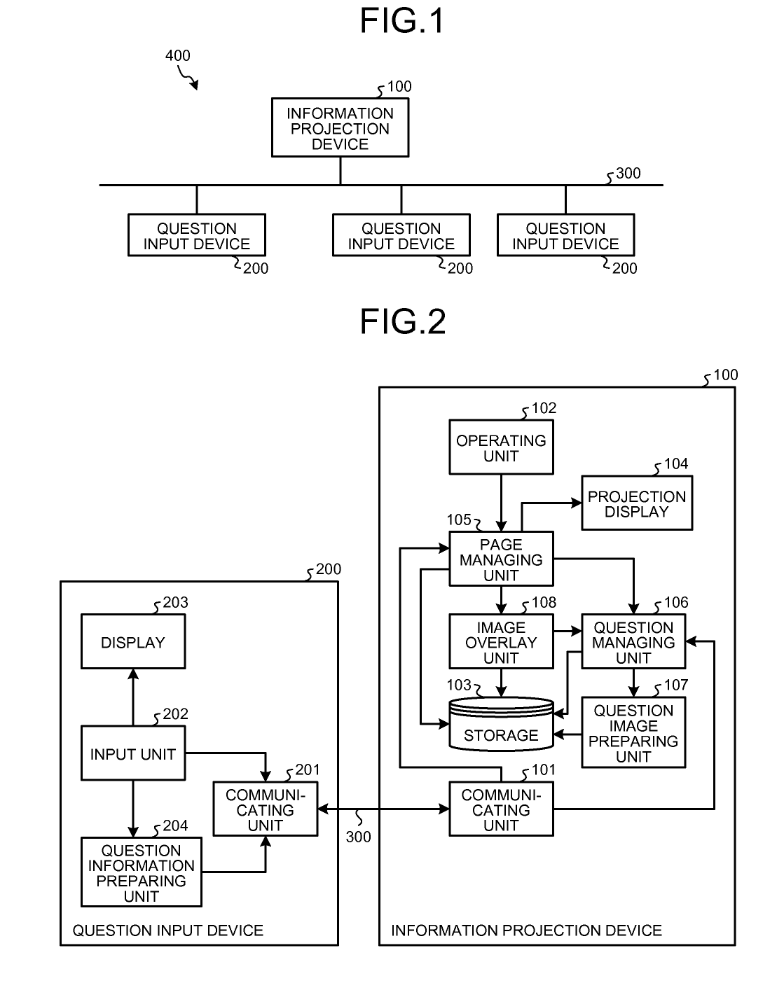

FIG. 1 is a block diagram illustrating a system configuration of an information projection system 400. FIG. 2 is a functional block diagram illustrating a configuration of an information projection device 100 and a question input device 200. The information projection system 400 according to an embodiment includes the information projection device 100 as a display control device and a plurality of question input devices 200 such as personal computers (PCs), each being connected to a network 300 such as the Internet or a local area network (LAN).

The information projection device 100 corresponds to, for example, but is not limited to, a projector that projects and displays contents of document data on a projection screen.

The question input devices 200 will be described in detail below. Each of the question input devices 200 mainly includes, as illustrated in FIG. 2, a communicating unit 201, an input unit 202, a display 203, and a question information preparing unit 204.

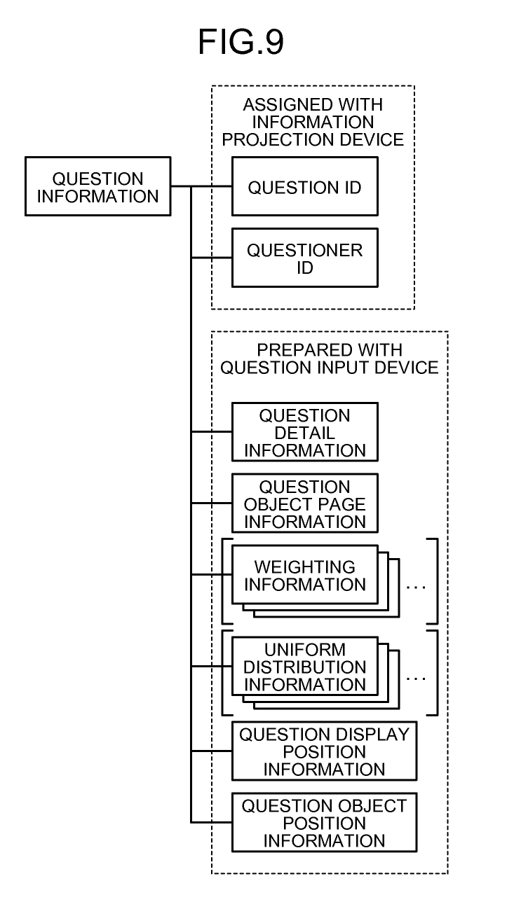

The communicating unit 201 transmits and receives various types of information and requests to and from the information projection device 100. For example, the communicating unit 201 transmits question information (see FIG. 9) to be described later to the information projection device 100.

The display 203 refers to and displays a display image stored in a storage 103 of the information projection device 100 via the communicating unit 201.

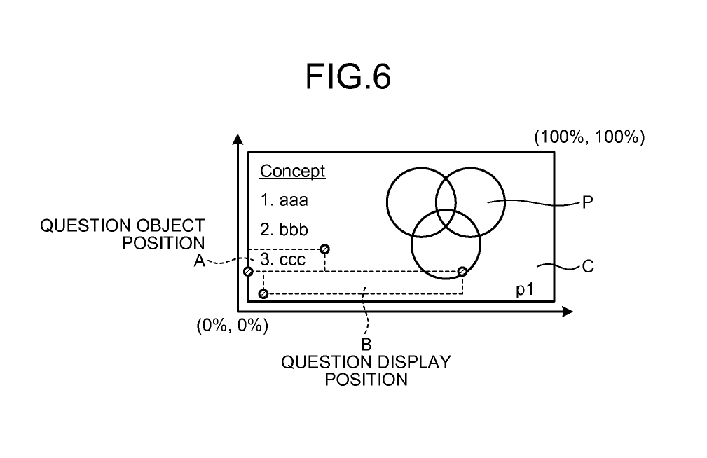

The input unit 202 receives an input to an image displayed on the display 203. For example, the input unit 202 specifies a question display position and a question object position on an image displayed on the display 203. For example, if the question input device 200 is a terminal such as a mobile PC, ranges on an image displayed on the display 203 are selected via the input unit 202 using a pointing device (not illustrated) such as a mouse, so that a question object position A and a question display position B are specified (see FIG. 6)

More specifically, the input unit 202 determines whether the input is for the question object position A or the question display position B according to an order of selecting the ranges. The input unit 202 calculates relative coordinates in an image (e.g., material) displayed on the display 203 based on the absolute coordinates of the question object position A and the question display position B input using the pointing device (not illustrated) such as a mouse. The input unit 202 defines the calculated relative coordinates as the question object position A and the question display position B of the question information.

Additionally, the input unit 202 receives an input of a text describing a question detail to the image displayed on the display 203.

The question information preparing unit 204 prepares the question information for the image displayed on the display 203 based on question detail information, question object position information, and question display position information input via the input unit 202.

The information projection device 100 will be described in detail below. The information projection device 100 mainly includes, as illustrated in FIG. 2, a communicating unit 101, an operating unit 102, the storage 103, a projection display 104 as a display, a page managing unit 105, a question managing unit 106, a question image preparing unit 107, and an image overlay unit 108.

The communicating unit 101 transmits and receives various types of information and requests to and from the question input device 200. For example, the communicating unit 101 receives question information transmitted from the question input device 200.

The projection display 104 projects and displays various types of image data on a screen in a display mode specified by a user.

The operating unit 102 receives an operation request for to the information projection device 100 from outside. For example, the operating unit 102 receives an instruction from the user to interrupt projection display on the projection display 104. The operating unit 102 also receives an instruction from the user to resume the projection display after the interruption of the projection display on the projection display 104.

The operating unit 102 is an input device including, for example, buttons, a remote control receiver, and a card reader that reads information from, for example, an IC card. It is noted that the operating unit 102 may provided with a keyboard.

The storage 103 is a recording medium such as a hard disk drive (HDD), storing therein, for example, document data and image lists to be described later. Examples of the document data include, but are not limited to, data created using presentation-material preparing software, a word processor, or the like, and display data converted from these types of data.

The page managing unit 105, on receipt of a question display request from the operating unit 102, schedules the order and time for each question in a question-and-answer session and identifies questions to be displayed. The page managing unit 105 switches images to the next slide when a period of time to display a question elapses.

The question managing unit 106, on receipt of question information from the question input device 200, assigns a question ID and a questioner ID that serve as identification control information to the question information.

The image overlay unit 108 makes a question image preparing request to the question managing unit 106 based on the question information specified by the page managing unit 105, thereby creating an image including a question superimposed over a slide.

The question image preparing unit 107 determines the size of the question image based on the question display position information and the question object position information contained in the question information and draws the question detail and the name of the questioner.

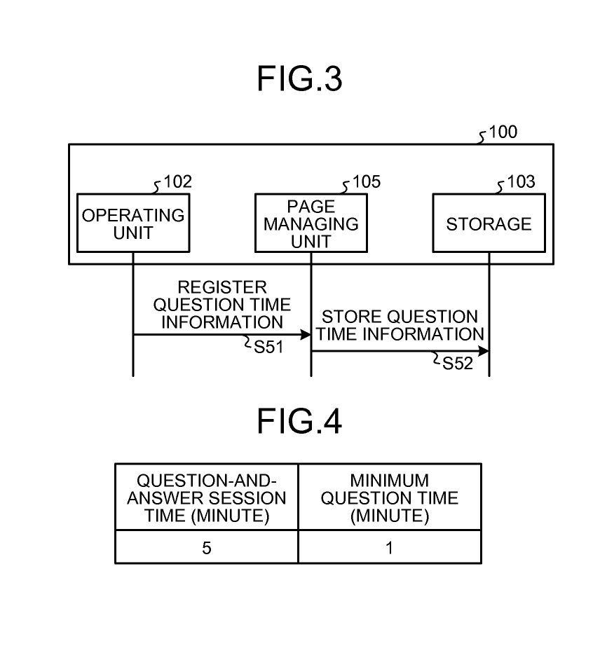

Next, a process for registering question-and-answer session time performed by the information projection system 400 of this embodiment having the arrangements as described above will be described below. FIG. 3 is a sequence diagram illustrating the process for registering the question-and-answer session time.

As illustrated in FIG. 3, when question time information is registered from the operating unit 102 to the page managing unit 105 of the information projection device 100 (step S51), the page managing unit 105 stores the question time information in the storage 103 (step S52).

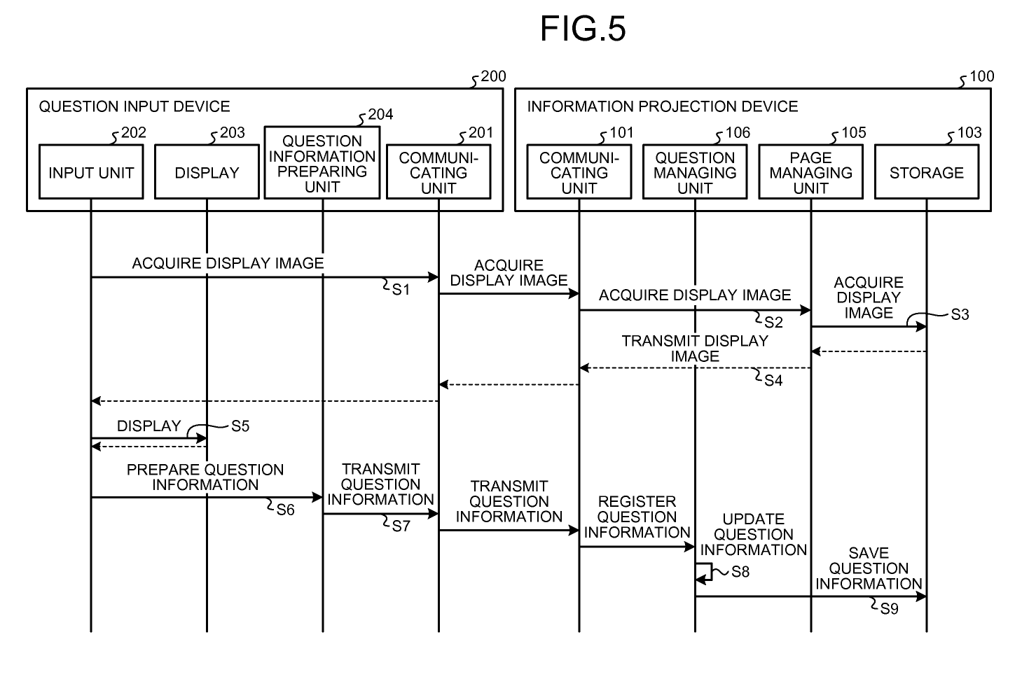

A data structure registered as the question time information includes the following two items as illustrated in FIG. 4.

Question-and-answer session time: Represents total time in minutes of a question-and-answer session (overall time involved in questions and answers)

Minimum question time: Represents minimum time required by a single question.

If there is a question that fails to satisfy the minimum question time requirement, a question with the lowest priority (a question to be displayed last) is not displayed to be handled after the session and is thus deleted from scheduling of the question time. Such an arrangement allows the question-and-answer session to focus on questions with high priority within a limited amount of time available. Alternatively, if there are no questions that fail to satisfy the minimum question time requirement (specifically, if there is time left after the minimum question time is allotted to each question), a greater amount of time is allotted to questions with higher priority (a question to be displayed first). Such an arrangement allows a longer time to be spent on the question-and-answer session for questions with high priority within a limited amount of time available. A scheduling method will be described in detail later.

Next, a process for registering question information performed by the information projection system 400 of this embodiment having the arrangements as described above will be described below. FIG. 5 is a sequence diagram illustrating the process for registering the question information.

The question input device 200 inputs the questioner ID as it accesses the information projection system 400 and transmits an instruction to acquire a display image input through the input unit 202 to the information projection device 100 via the communicating unit 201 (step S1).

On receipt of the instruction to acquire a display image via the communicating unit 101 (step S2), the information projection device 100 acquires through the page managing unit 105 the display image (display data) from the storage 103 based on the instruction to acquire the display image received (step S3). It is here noted that the display image to be acquired is, for example, an image P (see FIG. 6).

The information projection device 100 thereafter transmits the display image (display data) acquired to the question input device 200 via the communicating unit 101 (step S4).

On acquisition of the display image from the information projection device 100 via the communicating unit 201, the question input device 200 displays the display image acquired on the display 203 (step S5).

Next, the question input device 200 prepares question information at the question information preparing unit 204 based on an input made via the input unit 202 on the image displayed on the display 203 (step S6).

FIG. 6 is a schematic diagram illustrating an input example in preparation of the question information. As illustrated in FIG. 6, the questioner specifies the question object position A, the question display position B, and a question object page C on the image P displayed on the display 203 and inputs the question detail using the input unit 202.

Because the questioner has input means with which he or she can specify the question object position A and the question display position B, and thus can specify the question object position and the question display position as described above, it is easy for a presenter to understand the question.

When the question detail and the like are input as described above, the question input device 200 prepares the question information at the question information preparing unit 204 based on the question detail information, the question object position information, the question display position information, and the question object page information all of which are input. The question input device 200 then transmits the question information to the information projection device 100 via the communicating unit 201 (step S7).

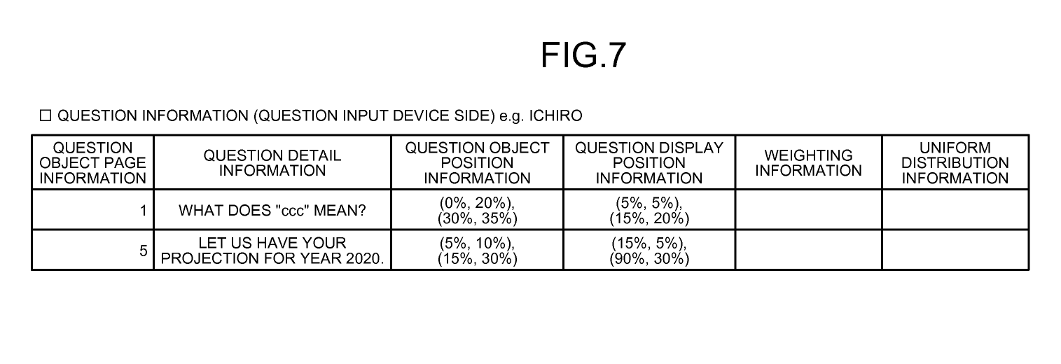

Here, an example of question information prepared on the question input device 200 side is illustrated in FIG. 7. In the example of question information illustrated in FIG. 7, the question input device 200 used by “Ichiro” has pages “1” and “5” as question object pages, each having inputs of the question detail information, the question object position information, and the question display position information. The question detail information represents the question detail of the questioner. The question object page information represents the page about which the questioner wants to ask a question. The question object position information represents position information of a location about which the questioner wants to ask a question. The question display position information represents position information of a location at which the questioner wants to display the question detail.

The question information may also include weighting information (e.g., question priority level) and uniform distribution information (e.g., participant role) of the question. The weighting information and the uniform distribution information are retained by the storage 103 of the information projection device 100. Each piece of the weighting information and the uniform distribution information may be provided in plurality.

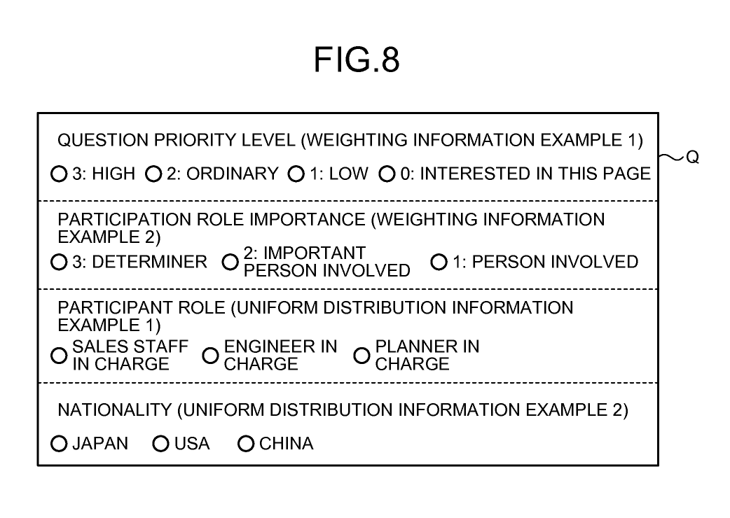

The question information preparing unit 204 of the question input device 200 acquires a display image Q as illustrated in FIG. 8 from the storage 103 of the information projection device 100 and displays the display image Q on the display 203. The question information preparing unit 204 further allows the questioner to input the weighting information (e.g., question priority level, participation role importance) and the uniform distribution information (e.g., participant role, nationality) of the question manually by way of the display image Q. With this interface (display image Q) that permits selection of selection items for the weighting information and the uniform distribution information as described above, it is possible to allow the questioner to input each of these items manually during registration of the question, thereby allowing the questioner to weight questions freely according to specific details of the presentation and importance of the questions.

It is noted that the question managing unit 106 of the information projection device 100 retains user information of the questioner, so that the selection items of at least either the weighting information or the uniform distribution information may be input automatically based on the questioner ID. In this manner, the user information is retained and, during registration of the question information from the questioner, the weighting information and the uniform distribution information may be retained as being linked to the questioner. This allows the system to link items unique to a specific user automatically without requiring manual input.

The weighting information (e.g., question priority level) serves as weighting information of the question to be used for scheduling. The weighting information is intended to ensure that a question having high weighting takes precedence over other questions having lower weighting. Details will be described later.

For the uniform distribution information (e.g., participant role), the uniform distribution information of participants in the presentation is input. The uniform distribution information is used for scheduling of questions. The uniform distribution information is used for the scheduling of questions from participants having as many different characteristics as feasible. Details will be described later.

The uniform distribution information refers to attributes of the questioner (e.g., nationality, age, and sex). The term “uniform distribution” is herein used to contrast with the weighting information. The weighting information is intended to ensure that a question having high weighting takes precedence over other questions having lower weighting. Unlike the weighting information, the uniform distribution information is not intended for weighting.

On receipt of question information via the communicating unit 101, the information projection device 100 uses the question managing unit 106 to update the question information by assigning a question ID, a questioner ID, etc. thereto (step S8). The question ID is assigned in order of reception of questions. The questioner ID is assigned based on the question input device 200 that has transmitted the question information.

Thereafter, the information projection device 100 saves the question information in the storage 103 (step S9).

FIG. 9 is a schematic diagram illustrating a data structure of the question information. As illustrated in FIG. 9, the question information includes the question ID, the questioner ID, the question detail information, the question object page information, the question display position information, and the question object position information. The question detail information, the question object page information, the question display position information, and the question object position information are prepared at the question input device 200 based on the input by the questioner as described earlier. As also illustrated in FIG. 9, the question information may further include the weighting information (e.g., question priority level) and the uniform distribution information (e.g., participant role).

The question ID and the questioner ID are assigned to the question information by the question managing unit 106 of the information projection device 100 as described earlier. The question ID is an identifier of the question information, and is assigned by the question managing unit 106 in order of reception of questions. The questioner ID is an identifier of the questioner, and is assigned based on the question input device 200 that has transmitted the question information.

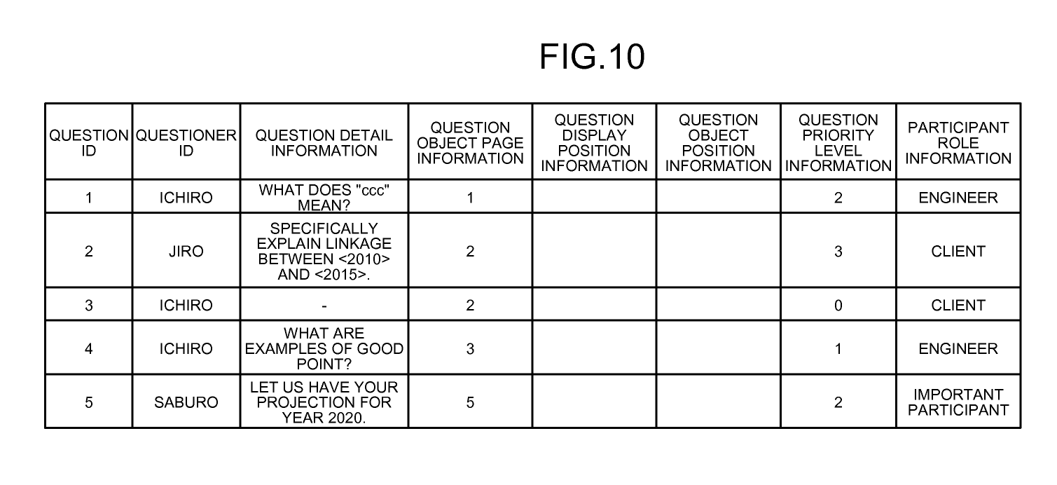

An example of question information is illustrated in FIG. 10. In the example of question information illustrated in FIG. 10, the question object page information, the question detail information, the question display position information, the question object position information, the weighting information (e.g., question priority level), and the uniform distribution information (e.g., participant role) are prepared in the question input device 200 used by “Ichiro”. The information projection device 100 assigns the question ID (“1”) in order of reception of questions and adds the questioner ID (“Ichiro”).

The question priority level information as an example of the weighting information is specified by the question input device 200. As illustrated in FIG. 10, the weighting information is specified in descending order (3, 2, 1, 0). For the participant role information as an example of the uniform distribution information, the role of the participant is input.

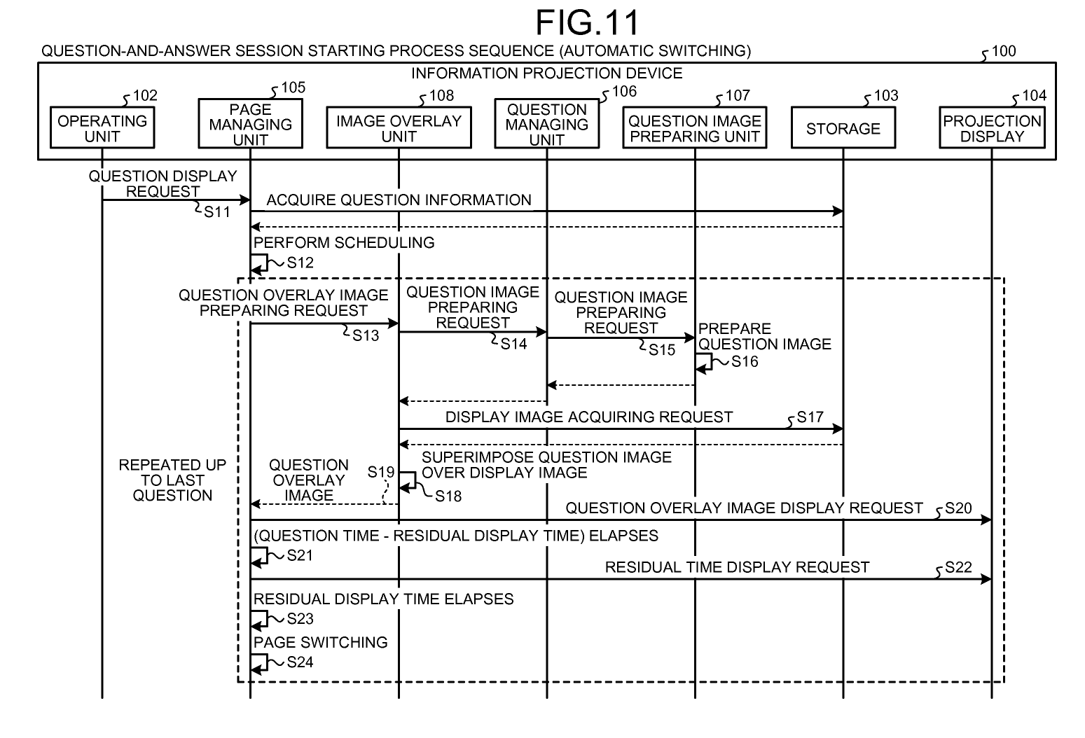

A process for starting the question-and-answer session in the information projection device 100 will now be described. FIG. 11 is a sequence diagram illustrating the process for starting the question-and-answer session.

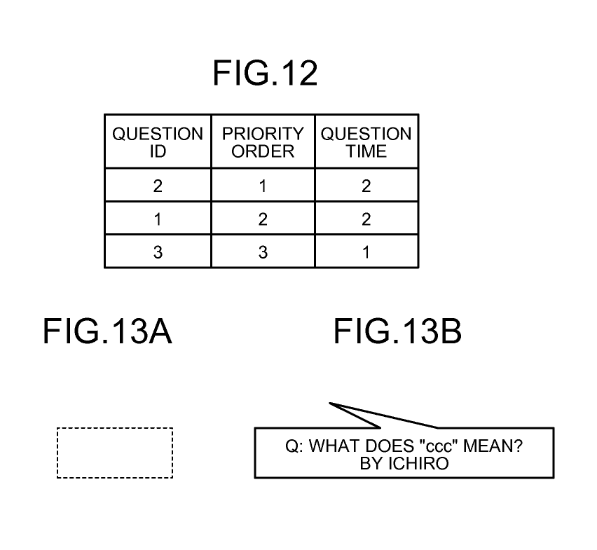

Upon receiving a question display request from the operating unit 102 (step S11), the information projection device 100 uses the page managing unit 105 to acquire the question information from the storage 103, performs scheduling of question order and question time for each question (step S12), and prepares and holds a mapping table that maps each question ID to the priority order and question time as illustrated in FIG. 12.

After performing the scheduling, the information projection device 100 causes the page managing unit 105 to make a question overlay image preparing request to the image overlay unit 108 based on the priority order (step S13).

Then, the information projection device 100 causes the image overlay unit 108 to make a question image preparing request to be displayed on the question managing unit 106 (step S14) and the question managing unit 106 to make a question image preparing request to the question image preparing unit 107 (step S15).

Then, the information projection device 100 causes the question image preparing unit 107 to prepare a question image based on the question information (step S16). FIGS. 13A and 13B are schematic diagrams illustrating a method for preparing a question image. The method for preparing the question image is as follows. As illustrated in FIG. 13A, the size of an image indicating the question object position is first determined based on the question object position information and the image is prepared. Then, as illustrated in FIG. 13B, the size of an image that displays the question is next determined based on the question display position information and the question detail and the questioner name are drawn. The question image thus prepared by the question image preparing unit 107 is saved in the storage 103.

Then, the information projection device 100 causes the image overlay unit 108 to acquire the question image of the display image of the object question from the storage 103 (step S17) and to thereby superimpose the question image over the display image (step S18). Then, the information projection device 100 causes the page managing unit 105 to acquire the overlay image from the image overlay unit 108 (step S19) and to make a display request to the projection display 104 (step S20).

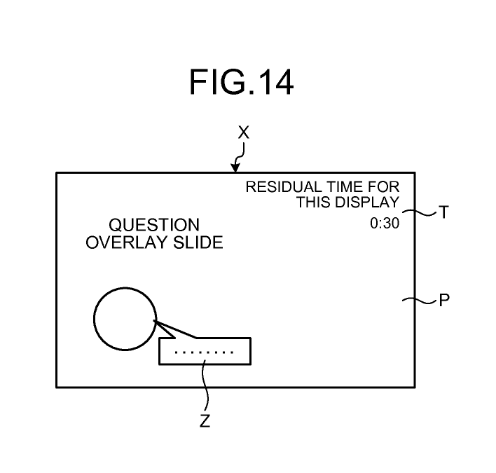

After the display of the question overlay image is started, the information projection device 100 causes the page managing unit 105 to measure time with a timer (step S21) and, when (question time−residual display time) elapses, to make a residual time display request to the projection display 104 (step S22). FIG. 14 illustrates an example of a screen that shows a residual display time T to be displayed on an overlay image X that includes a question image Z of each question during display control of the question-and-answer session overlay image performed by the page managing unit 105. The residual display time T allotted to each question is displayed on the overlay image X as illustrated in FIG. 14, which allows the question-and-answer session to be conducted with the residual display time of the question in mind.

When the page managing unit 105 thereafter determines that the residual display time has elapsed (step S23), the information projection device 100 causes the page managing unit 105 to switch pages (step S24) and to make a question overlay image preparing request for the next question based on the priority order to the image overlay unit 108 (step S13).

Specifically, the information projection device 100 repeats the sequence of preparing and displaying question images up to the last question as illustrated in steps S13 through S24.

As such, pages are automatically switched to the next question upon a lapse of a predetermined period of time from the start of the question display for each question. This eliminates the need for the presenter to perform a page switching operation whenever such an operation is needed, thus permitting automatic schedule management of questions.

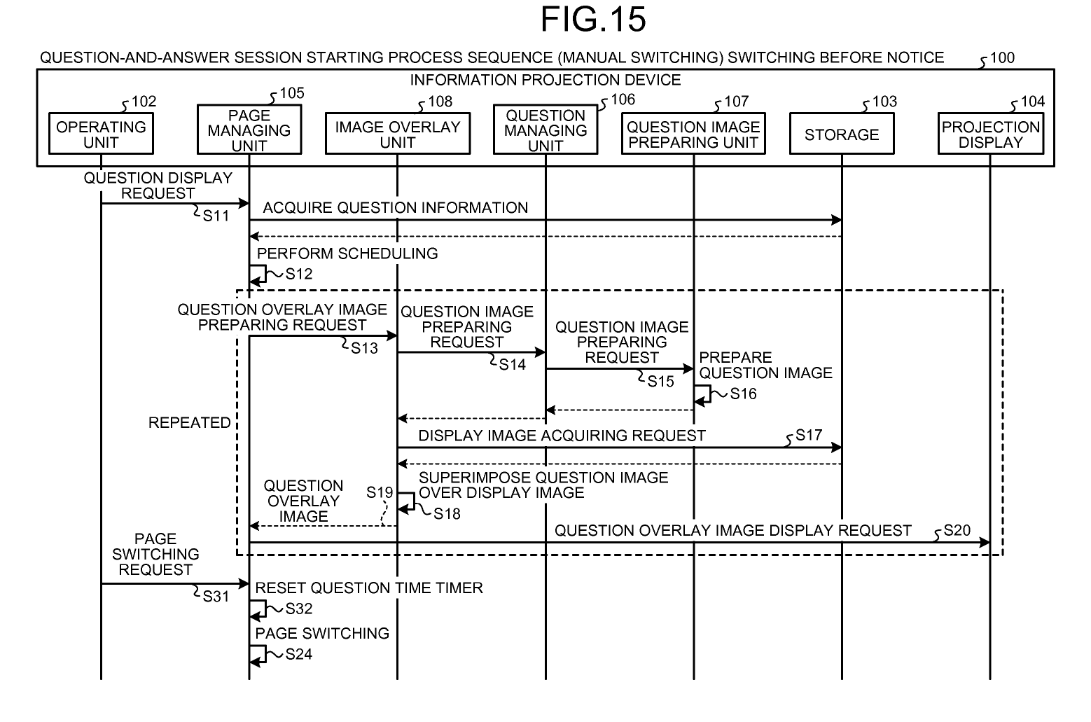

FIG. 15 illustrates an example of manual page switching. As illustrated in FIG. 15, after the information projection device 100 makes a display request to the projection display 104 (step S20) and if a question-and-answer session is completed for the object question ahead of the scheduled time (question time—residual display time), the operating unit 102 is manually caused to make a page switching request (image switching request) (step S31) and the page managing unit 105 is caused to reset the timer (step S32), and page switching is performed (step S24), before proceeding to the next question.

A manual operation on the operating unit 102 performed by an operator after the start of the question display for each question can skip the residual time to thereby switch pages to the next question as described above. This permits a shift to the next question when questions are answered earlier than the scheduled question time.

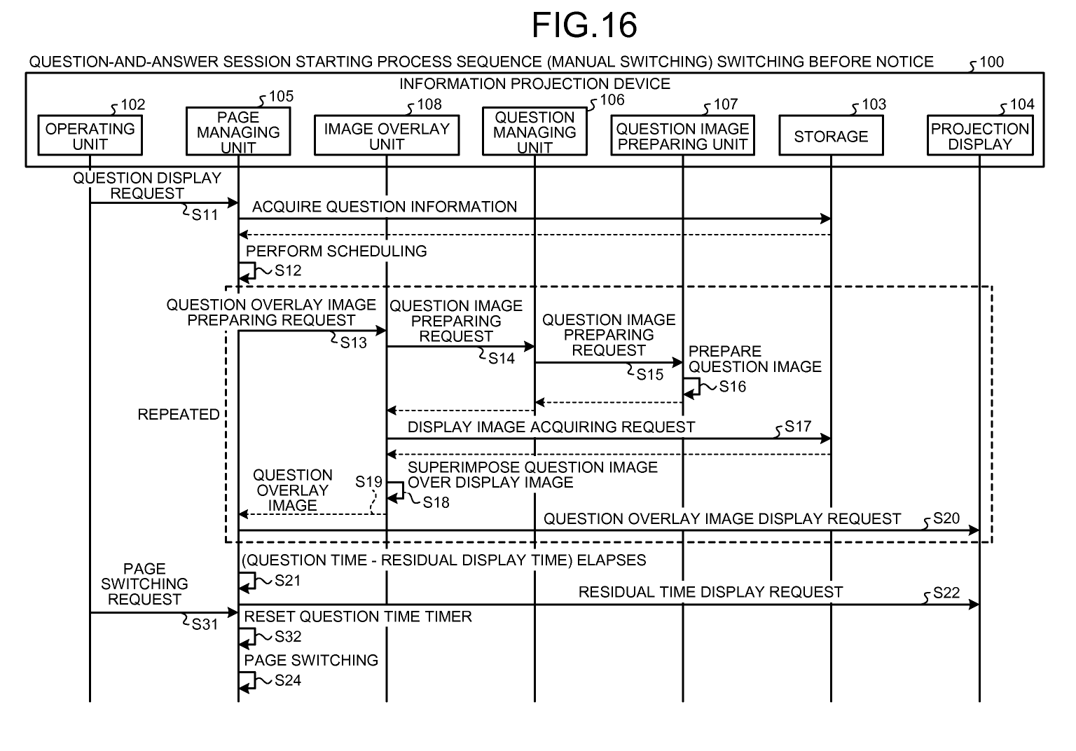

FIG. 16 illustrates an example of a manual switching request made after a residual time display request made after the lapse of (question time−residual display time). As illustrated in FIG. 16, the information projection device 100 makes a display request to the projection display 104 (step S20) and, after the lapse of (question time−residual display time) (step S21), makes a residual time display request to the projection display 104 (step S22). Then, when a page switching request (image switching request) is made manually through the operating unit 102, the information projection device 100 causes the page managing unit 105 to reset the timer (step S32), and page switching is performed (step S24), before proceeding to the next question.

Next, an example of an overlay image of a question image and a display image based on the foregoing process will now be described.

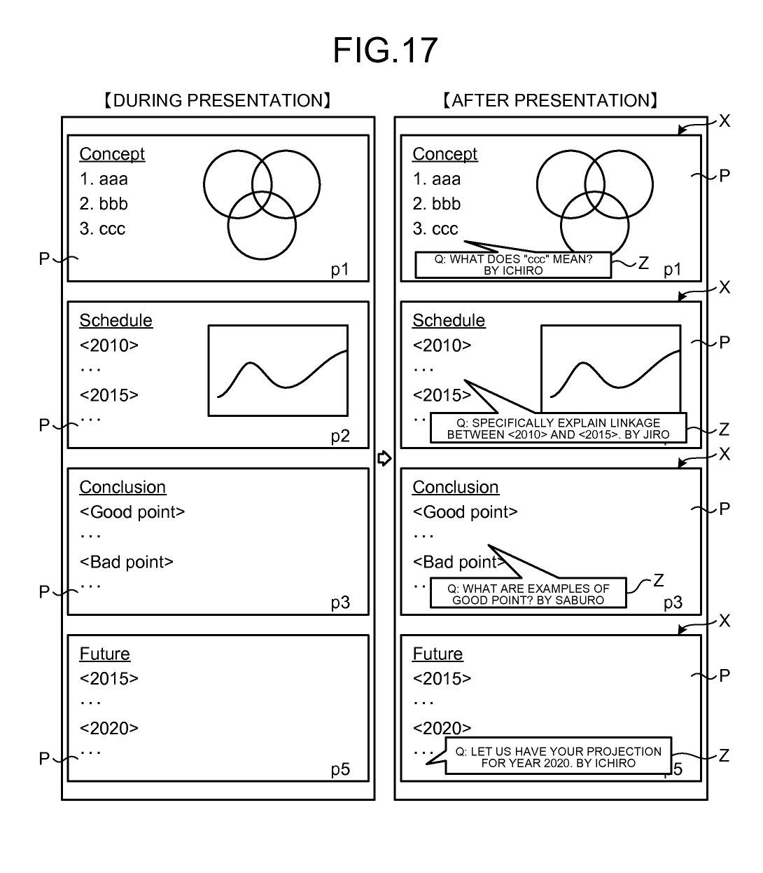

FIG. 17 illustrates a display image P during presentation and an overlay image X displayed after the presentation. As illustrated in FIG. 17, the overlay image X displayed after the presentation has the question image (an image representing a question location and an image representing the question detail) Z overlaid thereover in order of the question ID illustrated in FIG. 10.

In addition, as illustrated in FIG. 17, the page managing unit 105 prepares the question image Z for each question. As such, the question detail is displayed without being superimposed over a question location, which clarifies a question object location, so that the presenter can readily understand the question detail.

Next, examples of the scheduling process of the question order and question time for each question performed by the page managing unit 105 of the information projection device 100 will be described below.

### First Example

### Example of Scheduling Based on Weighting Information

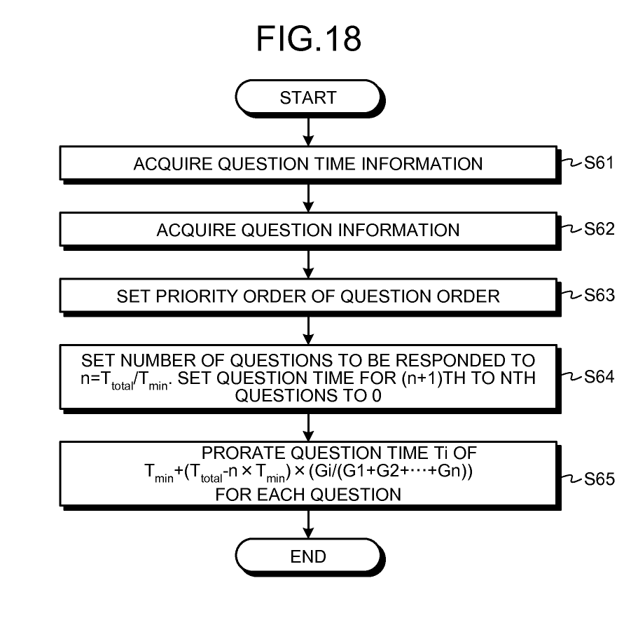

FIG. 18 is a flowchart illustrating a scheduling process. As illustrated in FIG. 18, the page managing unit 105 first acquires the question time information including the question-and-answer session time and the minimum question time illustrated in FIGS. 3 and 4 (step S61). The page managing unit 105 also acquires the question information illustrated in FIGS. 8 and 9 (step S62) and determines the priority order of the question order based on the question information (step S63).

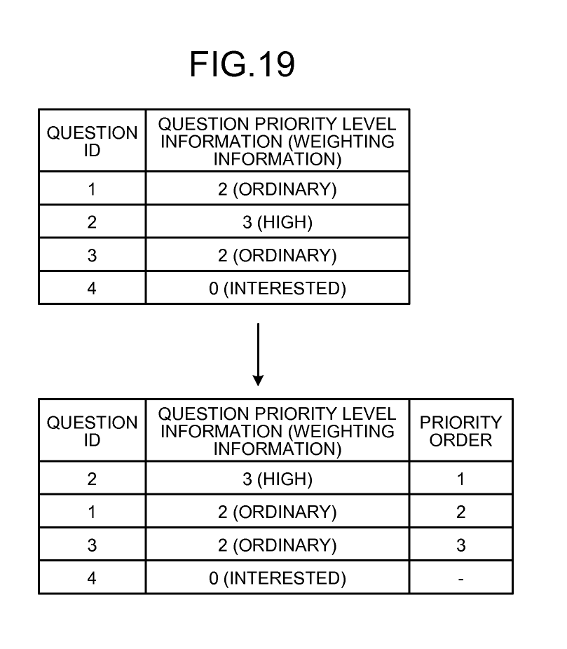

FIG. 19 is a diagram illustrating an example of a priority order set based on the weighting information of the question information. As illustrated in FIG. 19, when the priority order is to be set based on the weighting information of the question information, the question with the greatest numerical value of the weighting information (in the example, a question ID 2) is given the highest priority. If the numerical values of the question priority level information are identical between questions, the one asked first is given higher priority. Any question having 0 for the question priority level information (a question ID 4) asks nothing as described with reference to FIG. 10 and is not given any priority.

Next, the page managing unit 105 determines the number n of questions to be responded by dividing the total question-and-answer session time Tₜₒₜₐₗ by the minimum question time Tₘᵢₙ and defines the question time for questions from a question with the (n+1)th priority to the Nth registered question to be 0 (step S64).

The page managing unit 105 then prorates question time Tᵢ for each question based on weighting information G1 (step S65). The question time Tᵢ can be represented by the following formula:

Ti=Tmin+(Ttotal−n×Tmin)×(Gi/(G1+G2+ . . . +Gn))

A highly effective question-and-answer session can be conducted by giving a question with high weighting (priority level) high priority to thereby allot a longer period of time and giving such a question a lower question order to thereby elongate the question time.

### Second Example

### Example of Scheduling Based on Uniform Distribution Information

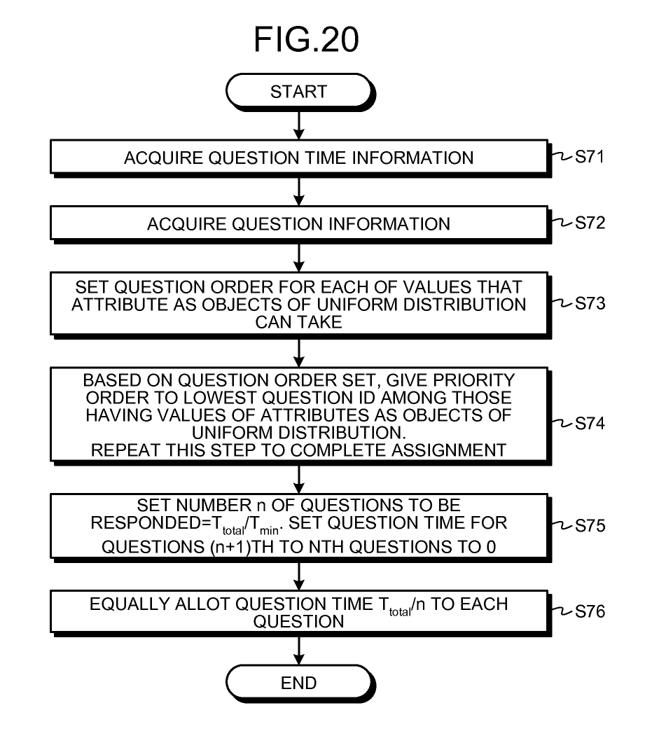

FIG. 20 is a flowchart illustrating a scheduling process. As illustrated in FIG. 20, the page managing unit 105 first acquires the question time information including the question-and-answer session time and the minimum question time illustrated in FIGS. 3 and 4 (step S71). The page managing unit 105 also acquires the question information illustrated in FIGS. 8 and 9 (step S72) and determines, based on the question information, the question order for each value that attributes as objects of the uniform distribution can take (step S73).

The number of values that the uniform distribution attributes can take is “3” if, for example, three nationalities, namely, Japan, the U.S., and China, of the questioners are involved. The order of the uniform distribution information is set such that the lower the question ID assigned to the question information, the higher the priority (in other words, on a first-come, first-served basis). For example, if questions are as listed below, the order of the uniform distribution information is set in ascending order of the question IDs of the uniform distribution information (Japan->the U.S.->China).

Question ID 1: Japan

Question ID 2: Japan

Question ID 3: the U.S.

Question ID 4: China

The priority order is set in ascending order of the question IDs of the uniform distribution information based on the order of the uniform distribution information set. In the example illustrated above, the priority order is as follows:

The first priority is given to the question ID 1 (which is assigned with the lowest question ID among those from Japanese questioners).

The second priority is given to the question ID 3 (which is assigned with the lowest question ID among those from the U.S. questioners).

The third priority is given to the question ID 4 (which is assigned with the lowest question ID among those from Chinese questioners).

The fourth priority is given to the question ID 2 (which is assigned with the second lowest question ID among those from Japanese questioners).

Use of the above-described method results in a different type of uniform distribution information being given higher priority among the same types of uniform distribution information arrayed consecutively.

It is noted that the order of the values that the attributes can take may be set in advance. Alternatively, the order may be set based on the order in which the lowest question ID is registered among the values that can be taken.

The page managing unit 105 then gives, based on the question order set for each of the values that the attributes as objects of the uniform distribution can take, the priority order to the lowest question ID among instances of each attribute. The page managing unit 105 repeats this step until the priority order is given to all question IDs (step S74).

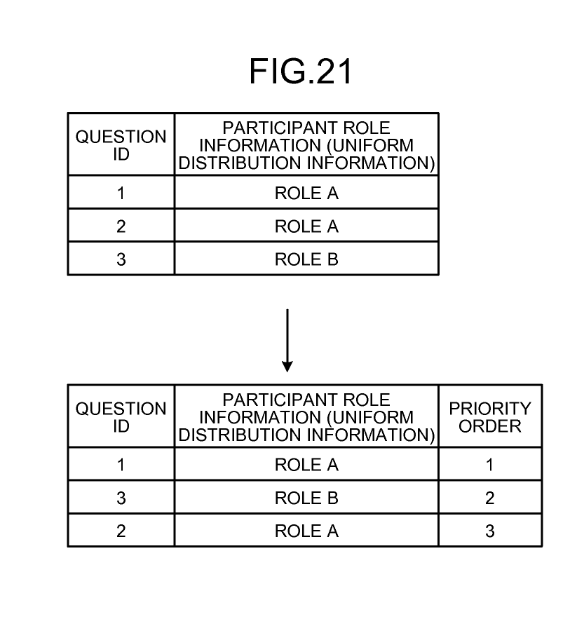

FIG. 21 is a diagram illustrating an example of a priority order set based on the uniform distribution information of the question information. As illustrated in FIG. 21, when the priority order is to be set based on the uniform distribution information of the question information, if the same types of uniform distribution information are arrayed consecutively, a different type of uniform distribution information is given higher priority. In this example, the question ID 3 of role B that is different in the uniform distribution information from the question ID 1 is given higher priority than the question ID 2 of role A.

Next, the page managing unit 105 determines the number n of questions to be responded by dividing the total question-and-answer session time Tₜₒₜₐₗ by the minimum question time Tₘᵢₙ and defines the question time for questions from a question with the (n+1)th priority to the Nth registered question to be 0 (step S75).

Finally, the page managing unit 105 equally allots the question time Tₜₒₜₐₗ/n to each question (step S76).

If questions from questioners having the same characteristic of the uniform distribution information are arrayed consecutively, the question from a questioner having a different characteristic of the uniform distribution information is given higher priority as described above. This arrangement allows a question-and-answer session to involve as many questioners having different characteristics from each other as possible in a presentation.

### Third Example

### Example of Scheduling Based on Question Object Page Information

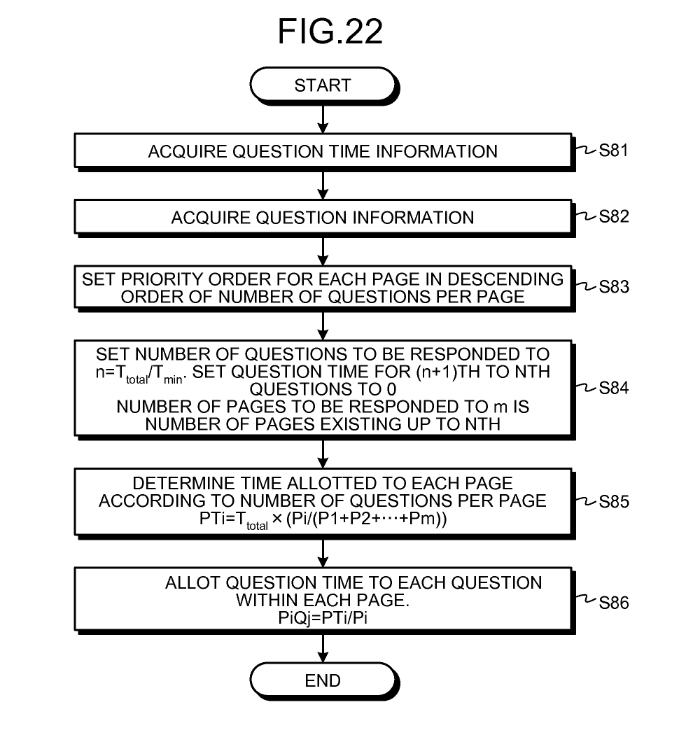

FIG. 22 is a flowchart illustrating a scheduling process. As illustrated in FIG. 22, the page managing unit 105 first acquires the question time information including the question-and-answer session time and the minimum question time illustrated in FIGS. 3 and 4 (step S81). The page managing unit 105 also acquires the question information illustrated in FIGS. 8 and 9 (step S82). If the question object page information shows that there are questions for the same page, the page managing unit 105 sets the priority order for each page in descending order of the number of questions contained in the page (step S83).

Next, the page managing unit 105 determines the number n of questions to be responded by dividing the total question-and-answer session time Tₜₒₜₐₗ by the minimum question time Tₘᵢₙ and defines the question time for questions from a question with the (n+1)th priority to the Nth registered question to be 0 (step S84). Note that the number m of pages to be responded is the number of pages existing up to the nth.

Then, the page managing unit 105 determines time PTi allotted to each page using the following formula according to the number of questions per page Pi (step S85).

PTi=Tₜₒₜₐₗ×(Pi/(P1+P2+ . . . +Pm))

Finally, the page managing unit 105 allots question time to each question within each page (step S86).

Question time of each question within each page PiQj=PTi/Pi

If there are a plurality of questions for the same page, scheduling is performed by setting an priority order and allotting time for each page as described above. The page having a plurality of questions often draws an attention and thus is given high priority to elongate the question-and-answer session time, so that a question-and-answer session can be conducted with an emphasis on the page in which participants are generally highly interested. Additionally, putting questions in the same page altogether enhances efficiency. A situation can also be prevented in which the question-and-answer session time is spent only on the same question.

### Fourth Example

### Example of Scheduling Based on Questioner IDs

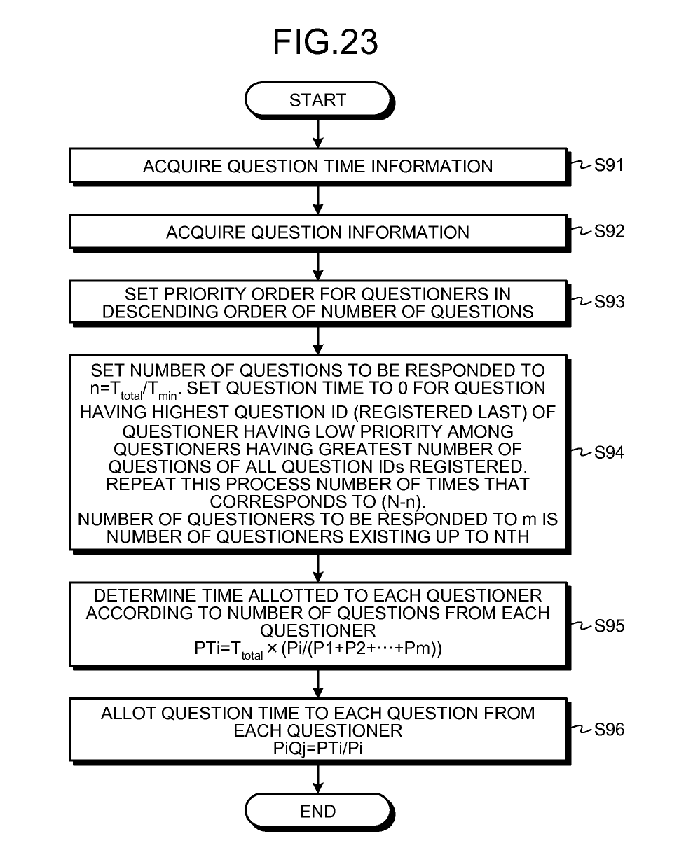

FIG. 23 is a flowchart illustrating a scheduling process. Referring to FIG. 23, the page managing unit 105 first acquires the question time information including the question-and-answer session time and the minimum question time illustrated in FIGS. 3 and 4 (step S91). The page managing unit 105 also acquires the question information illustrated in FIGS. 8 and 9 (step S92). If there is a plurality of questions from the same questioner ID, the page managing unit 105 sets the priority order for each questioner in descending order of the number of questions (step S93).

Next, the page managing unit 105 determines the number n of questions to be responded by dividing the total question-and-answer session time Tₜₒₜₐₗ by the minimum question time Tₘᵢₙ and defines the question time to be 0 for the question having the highest question ID (registered last) of the questioner with low priority among the questioners who have asked the greatest number of questions of all question IDs registered (step S94). This process is repeated the number of times that corresponds to “the number N of questions registered—the number n of questions to be responded”. Note that the number m of questioners to be responded is the number of questioners existing up to the nth.

Then, the page managing unit 105 determines time PTi allotted to each questioner using the following formula according to the number of questions per page (step S95).

PTi=Tₜₒₜₐₗ×(Pi/(P1+P2+ . . . +Pm))

Finally, the page managing unit 105 allots question time to each question from each questioner (step S96).

Question time of each questioner PiQj=PTi/Pi

For a plurality of questions from the same questioner ID, the priority order is set and time is allotted for each questioner ID as described above. Organizing questions for each questioner enhances efficiency and allotting time for each questioner allows a question-and-answer session to involve as many participants as possible.

### Fifth Example

### Example of Scheduling Based on a Plurality of Items

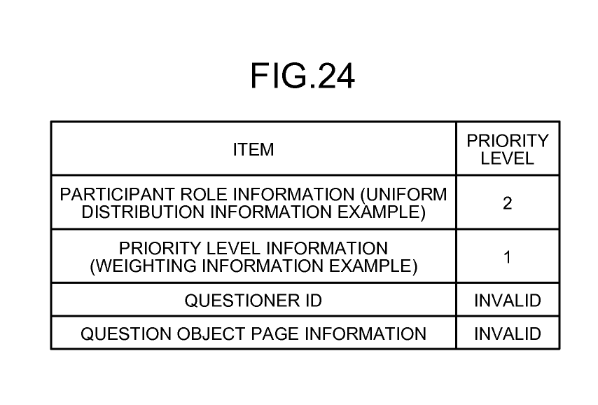

The priority order of the question order, and the question order can be set using a plurality of items described in the first to the fifth embodiments. When the priority order of the question order, and the question order are to be set using the items, the priority level of each item (smaller numbers have higher priority) and whether the item is valid or invalid are specified as illustrated in FIG. 24. In the example illustrated in FIG. 24, priority setting according to the question priority level information (an example of the weighting information) illustrated in FIG. 19 is given the highest priority, followed by the participant role information (an example of the uniform distribution information) illustrated in FIG. 21. Other items that are set to be invalid are not considered during scheduling.

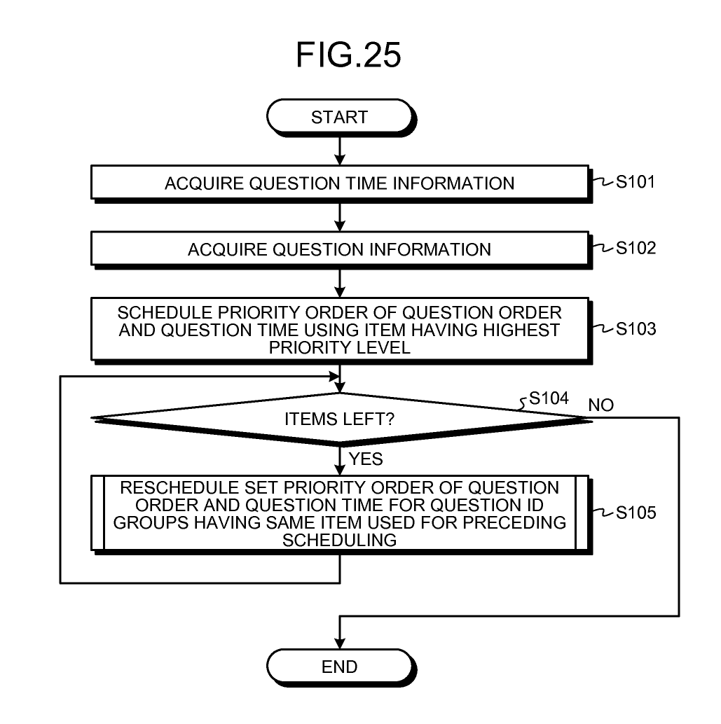

FIG. 25 is a flowchart illustrating a scheduling process. As illustrated in FIG. 25, when performing scheduling using a plurality of items, the page managing unit 105 acquires the question time information including the question-and-answer session time and the minimum question time illustrated in FIGS. 3 and 4 (step S101) and also acquires the question information illustrated in FIGS. 8 and 9 (step S102). The page managing unit 105 thus schedules the priority order of the question order and the question time using the item having the highest priority level (step S103).

Next, if there are other items left (Yes at step S104), the page managing unit 105 reschedules the set priority order of the question order and the question time for question ID groups having the same item used for the preceding scheduling (step S105). If there are no other items left (No at step S104), the page managing unit 105 terminates the process.

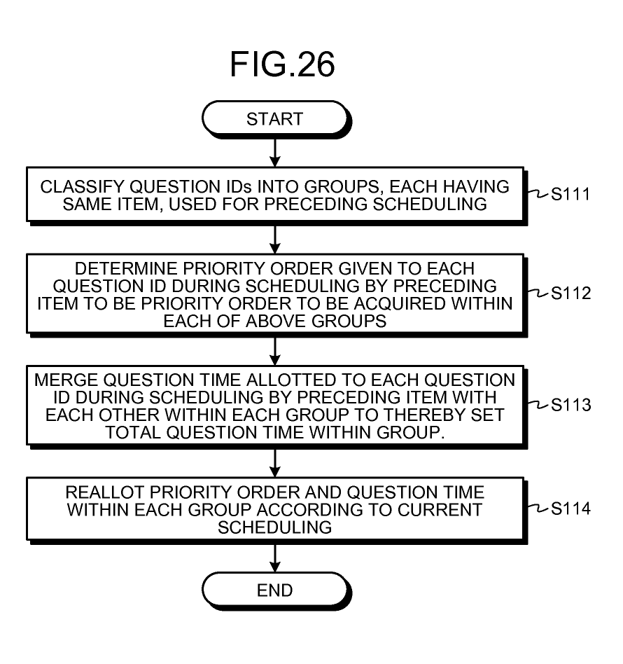

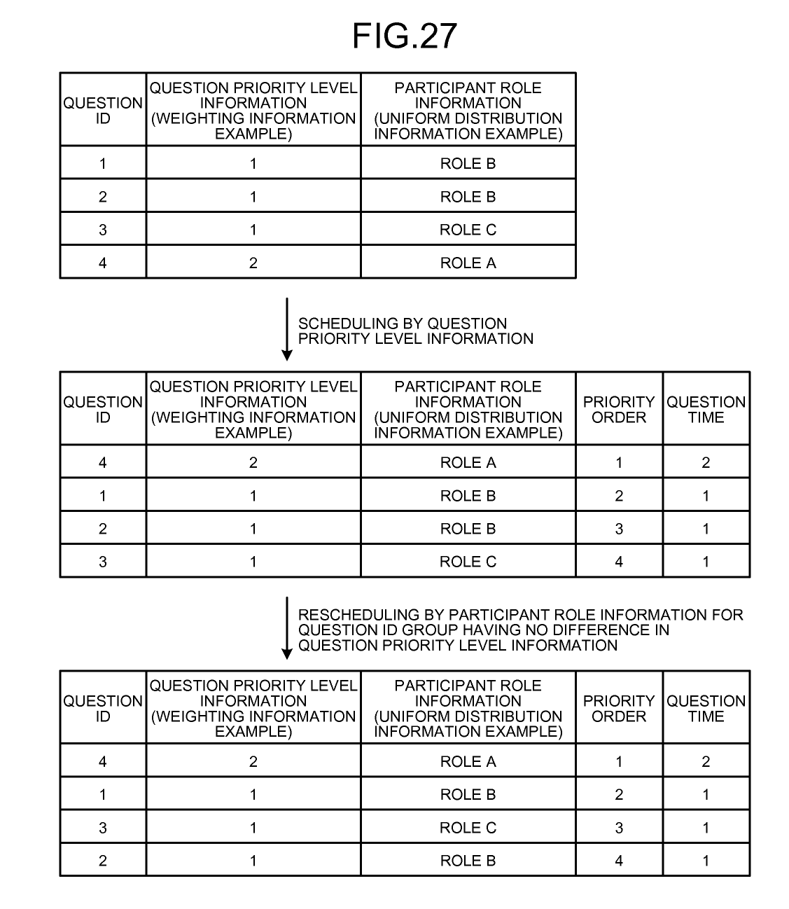

FIG. 26 is a flowchart illustrating a rescheduling process. FIG. 27 is a diagram illustrating specific examples of the rescheduling process. As illustrated in FIG. 26, the page managing unit 105 first classifies question IDs into groups each having the same item used for the preceding scheduling (step S111). In the example illustrated in FIG. 27, after the preceding scheduling according to the question priority level information, the question IDs are classified into two groups each having the question priority level information: one being the question ID 4 and the other being the question IDs 1, 2, and 3.

Next, the page managing unit 105 determines the priority order given to each question ID during the preceding scheduling by the items to be the priority order to be acquired within each of the above-mentioned groups (step S112). In the example illustrated in FIG. 27, the group having “1” for the question priority level information can take 2, 3, and 4 as the priority order.

Then, the page managing unit 105 merges the question time allotted to each question ID during the preceding scheduling by the items within each group to thereby set the total question time within the group (step S113). In the example illustrated in FIG. 27, the group having “1” for the question priority level information has “3=1+1+1” for the total question time.

Then, the page managing unit 105 reallots the priority order and the question time within each group according to the current scheduling (step S114).

As described above, a plurality of items are used for scheduling and, during the scheduling, the priority level of each item and whether the item is valid or invalid are specified. This allows scheduling to be performed by combining a plurality of items depending on the situation.

In the embodiments described heretofore, the question-and-answer session following the presentation given using the display image can be efficiently conducted within a set time by managing, based on the question information registered during the presentation, the display order and the display time of the object page for each question and switching the display of the overlay image of the question object according to the display order and the display time.

The information projection device 100 according to the embodiments has a hardware configuration incorporating an ordinary computer that includes a control unit such as a CPU, a storage unit such as a read only memory (ROM) and a RAM, an external storage unit such as an HDD and a CD drive unit.

A computer program to be executed on the information projection device 100 according to the embodiments is recorded in a computer-readable recording medium such as a CD-ROM, a flexible disk (FD), a CD-R, and a digital versatile disk (DVD) and provided in an installable or executable format file.

Another possible arrangement may have a computer program to be executed on the information projection device 100 according to the embodiments stored in a computer connected to the Internet or other network and have the computer program downloaded via the network. Still another arrangement may have a computer program to be executed on the information projection device 100 according to the embodiments provided or distributed via the Internet or other network.

The computer program of the embodiments may still be incorporated in, for example, a ROM in advance and provided accordingly.

The computer program to be executed on the information projection device 100 according to the embodiments has a modular configuration that includes the individual components described above (the communicating unit 101, the operating unit 102, the storage 103, the projection display 104, the page managing unit 105, the question managing unit 106, the question image preparing unit 107, and the image overlay unit 108). In operation, the CPU (processor) reads the program from the above-described recording medium; the CPU then executes the program to load the above-described individual components on the main memory, thus creating the communicating unit 101, the operating unit 102, the storage 103, the projection display 104, the page managing unit 105, the question managing unit 106, the question image preparing unit 107, and the image overlay unit 108 on the main memory.

In the embodiments described above, the information projection device 100, for example, a projector that projects and displays contents of document data on a projection screen, is applied as the display control device. This is, however, not the only possible arrangement; alternatively, a notebook personal computer (PC) may be employed.

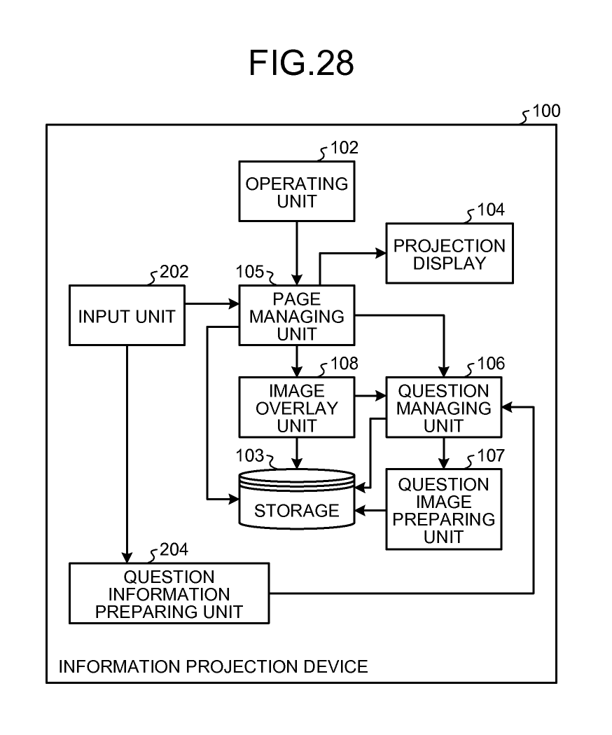

In the embodiments described above, the information projection system 400 includes the information projection device 100 and the question input device 200 both of which are connected to the network 300. This is, however, not the only possible arrangement; alternatively, as illustrated in FIG. 28, the information projection device 100 may have the functions of the question input device 200.

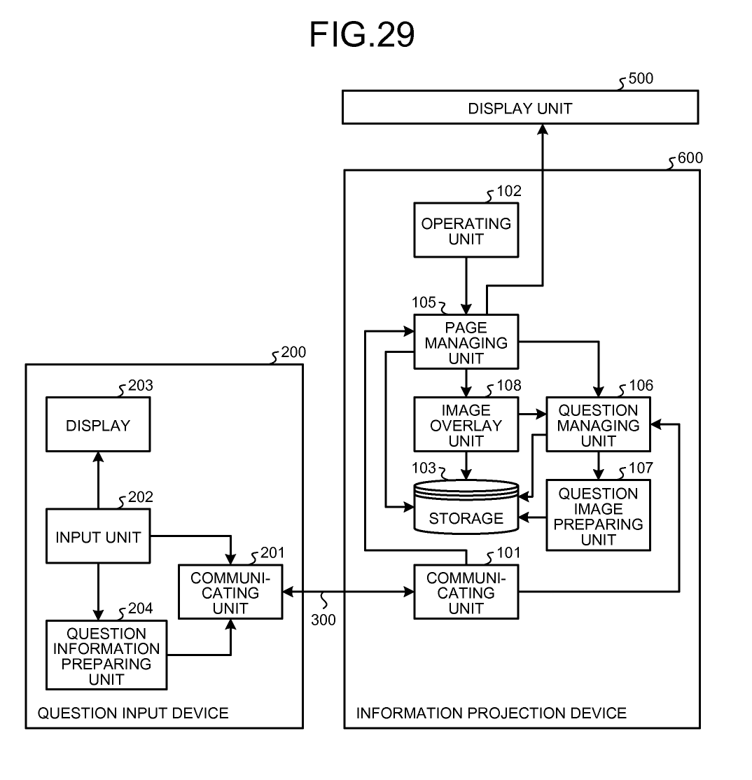

In the embodiments described above, the information projection device 100 including the projection display 104 as a display unit is applied as the display control device. This is, however, not the only possible arrangement; alternatively, as illustrated in FIG. 29, an information processing device 600 such as an ordinary personal computer (PC) that is separate from a display unit (e.g., an LCD) 500 may be applied as the display control device.

In addition, in the embodiments described above, a single device (such as the information projection device 100 and the information processing device 600) incorporates means for preparing question images, such as the storage 103, the page managing unit 105, the question managing unit 106, the question image preparing unit 107, and the image overlay unit 108. This is, however, not the only possible arrangement; alternatively, a display control device may be configured with a system that distributes the foregoing components to a plurality of units.

The present invention achieves an effect that a question-and-answer session following a presentation using display images can be efficiently conducted within a set time by managing, based on the question information registered during the presentation, the display order and the display time of the object page for each question and switching the display of the overlay image of the question object according to the display order and the display time.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display control device comprising:
a question managing unit that assigns identification control information to question information and manages the question information, the question information including a question detail of a question asked with an image displayed on a display specified, and a question object page indicating page number of the specified image;
a question image preparing unit that prepares a question image based on the question information;
an operating unit that receives various types of requests from outside;
a page managing unit that manages, when a display request of the question is received via the operating unit, a display order and display time of the question object page to be displayed based on the identification control information; and
an image overlay unit that prepares an overlay image including the question image superimposed over the specified image, wherein
the page managing unit causes the overlay image to be displayed on the display through switching according to the display order and the display time.

2. The display control device according to claim 1, wherein
the display time includes overall time involved in questions and answers and minimum question time required by a single question; and
the page managing unit does not cause the question object page to be displayed last to be displayed when there is any question that fails to satisfy the minimum question time.

3. The display control device according to claim 1, wherein
the display time includes overall time involved in questions and answers and minimum question time required by a single question; and
the page managing unit allots a longer time to the question object page to be displayed first when there is time left after the minimum question time is allotted to each question.

4. The display control device according to claim 1, wherein when a predetermined period of time elapses after display of the overlay image relating to a predetermined question starts, the page managing unit switches to the overlay image relating to a next question.

5. The display control device according to claim 1, wherein when an image switch request is made via the operating unit after display of the overlay image relating to a predetermined question starts, the page managing unit skips residual display time to display the overlay image and switches to the overlay image relating to a next question.

6. The display control device according to claim 5, wherein the page managing unit displays the residual display time on the overlay image.

7. The display control device according to claim 1, wherein
the question information includes weighting information that weights a question; and
the page managing unit gives, based on the weighting information, a question having high weighting high priority to allot a longer period of time.

8. The display control device according to claim 1, wherein
the question information includes uniform distribution information for uniformly distributing questions from questioners having different characteristics from each other; and
when questions from questioners having an identical characteristic are arrayed consecutively, the page managing unit gives a question from a questioner having a different characteristic higher priority based on the uniform distribution information.

9. The display control device according to claim 1, wherein when there are a plurality of questions for an identical question object page, the page managing unit gives the page a lower display order and elongates the display time.

10. The display control device according to claim 1, wherein the page managing unit manages the display order and the display time by unit of the identification control information for a plurality of questions having identical identification control information.

11. The display control device according to claim 1, wherein
the question information includes:
weighting information that weights a question; and
uniform distribution information for uniformly distributing questions from questioners having different characteristics from each other;
the page managing unit manages the display order and the display time by combining at least two control methods of:
giving, based on the weighting information, a question having high weighting high priority to allot a longer period of time;
giving a question from a questioner having a different characteristic higher priority based on the uniform distribution information when questions from questioners having an identical characteristic are arrayed consecutively;
giving the page a lower display order and elongates the display time when there are a plurality of questions for an identical question object page; and
managing the display order and the display time by unit of the identification control information for a plurality of questions having identical identification control information.

12. The display control device according to claim 1, further comprising:
an input unit that inputs, to an image displayed on the display, the question detail with the question object page specified; and
a question information preparing unit that prepares the question information including the question detail and the question object page input by the input unit.

13. The display control device according to claim 12, wherein
the input unit inputs at least one of the weighting information and the uniform distribution information; and
the question information preparing unit includes at least one of the weighting information and the uniform distribution information in the question information.

14. The display control device according to claim 13, wherein the question information preparing unit includes an interface that permits selection of a selection item for at least one of the weighting information and the uniform distribution information.

15. The display control device according to claim 13, wherein the question managing unit selects a selection item for at least one of the weighting information and the uniform distribution information based on the identification control information.

16. A question input device comprising:
an input unit that inputs, to an image displayed on a display by the display control device according to claim 1, a question detail with a question object page specified;
a question information preparing unit that prepares question information including the question detail and the question object page input by the input unit; and
a communicating unit that transmits the question information prepared by the question information preparing unit to the display control device.

17. A computer program product comprising a non-transitory computer-readable medium including programmed instructions, wherein the instructions, when executed by a computer, cause the computer to function as:
a question managing unit that assigns identification control information to question information and manages the question information, the question information including a question detail of a question asked with an image displayed on a display specified, and a question object page indicating page number of the specified image;
a question image preparing unit that prepares a question image based on the question information;
an operating unit that receives various types of requests from outside;
a page managing unit that manages, when a display request of the question is received via the operating unit, a display order and display time of the question object page to be displayed based on the identification control information; and
an image overlay unit that prepares an overlay image including the question image superimposed over the specified image, wherein
the page managing unit causes the overlay image to be displayed on the display through switching according to the display order and the display time.
